(19) United States
(12) Patent Application Publication
(10) Pub. No.: US 2012/0215384 A1
(43) Pub. Date: Aug. 23, 2012

(54) Flight Control System with Dynamic Allocation of Functionality Between Flight Crew and Automation

(75) Inventor: Steven L. Fritz, Columbia, MD (US)

(73) Assignee: Emerald Sky Technologies, LLC, Columbia, MD (US)

(21) Appl. No.: 13/505,055

(22) PCT Filed: Oct. 29, 2010
(86) PCT No.: PCT/US10/54763

§ 371 Date: Apr. 30, 2012

Related U.S. Application Data
(60) Provisional application No. 61/256,573, filed on Oct. 30, 2009.

(51) Int. Cl. G05D 1/08; G06F 7/00

(52) U.S. Cl. 701/2; 701/11

(57) ABSTRACT

A Real-time Allocation Flight Management System and method, which defines specific roles functions for crew during the implementation of the flight plan. The flight control system requires crew input during pre-programmed way points during the flight. When fully functional, the system can control all aspects of a flight, including attitude and power control as well as all ancillary systems necessary for flight from takeoff to touchdown. In the event that the crew is incapacitated, the system can select the most probable approach procedure in use based on whatever information is available such as current and forecast destination weather, prevailing winds, and approach possibilities, such as available runways. Adjustment of the flight plan trajectory, allows the system to follow the adjusted trajectory. Included is a simulator software program, a free-standing flight simulator and methods of incorporating training protocols for flight crews.

### CROSS REFERENCE TO RELATED APPLICATIONS

This application is a continuation-in-part of U.S. Provisional Application No. 61/256,573, filed Oct. 30, 2009, and is incorporated herein by reference in its entirety.

### GOVERNMENT INTERESTS

Certain research which gave rise to the present invention was supported by NASA Contract Number NNX09CE88P. Consequently, the United States government may retain certain rights in the invention.

### BACKGROUND

1. Field of the Invention

This invention relates to an automated flight control system.

2. Background of the Invention

Modem aircraft are typically flown by a computerized automatic flight control systems (also known as “autopilot”) and are regularly improved to enhance fight safety and reliability. (Urns, J. M., Sr.; Circuits and Systems, Intelligent flight control: what are the flight programs and why develop this technology? 2002. MWSCAS-2002. The 2002 45th Midwest Symposium on vol. 2, Aug. 4-7, 2002 pp. II-135-II-138 vol. 2.) A typical aircraft Flight Management System/Flight Control System (“FMS/FCS”) includes an autopilot that is capable of autonomous direction of the aircraft in flight as long as the desired sequence of actions has been pre-programmed by the flight crew. The sequence of actions includes a departure and destination point, a 3D route of flight that includes a path over the ground and climbs/descents. A complete flight trajectory also includes an approach segment that may be a predefined standard instrument approach procedure (“IAP”). The aircraft is typically either manually guided along the desired trajectory by the pilot following radio voice commands from Air Traffic Control (“ATC”) or autonomously guided by the FCS after the approach path is inserted into the existing trajectory during the terminal phase of flight.

Because of the safety of any flight is paramount and the complexity of the aircraft is increasingly greater than in the past, flight management systems and automated aircraft control has been a focus of improvements. For example, U.S. Pat. Nos. 7,801,649 and 7,734,411 (Gremmert) disclose a flight management system that provides for surveillance of hazards and selection and/or modification of a flight path. U.S. Pat. Nos. 7,751,948 and 7,188,007 (Boorman) disclose methods and systems for simplifying the operation of a flight management system.

A typical FMS/FCS is programmed manually by the pilot, whose role is largely to supervise and manage the FMS and insert new commands. Manual operation of the aircraft by the pilot is typically restricted to takeoff and landing phases of flight. A recent incident in which a Northwest Airline aircraft overflew its destination by 150 miles while the flight crew was distracted or otherwise incapacitated illustrates the potential problems of this approach. Military jets stood by as Northwest Airline pilots, apparently distracted, didn't respond to controllers for 75 minutes. (Minneapolis Star Tribune, Oct. 23, 2009.) Once the FMS is programmed, the pilot must exercise vigilance for errors that are extremely low probability, a difficult task to attend to on a continuous basis.

The present invention was developed out of a project to determine how to measure the ability of a flight crew to conduct a flight safely through metrics on required crew control inputs. The results suggested that timeliness of required crew inputs was a sensitive indicator of degraded functional capability of the crew. Therefore, there exists a need in the art to develop a flight control system which overcomes the difficulty in maintaining flight crew attention and functional capability even during mundane and routine flights and maneuvers.

### SUMMARY OF THE INVENTION

The present invention is drawn to a Real-time Allocation Flight Management System (“RFA FMS”), which defines specific roles (and associated functions) for crew and automation in the conduct of a flight and reallocates these roles and functions dynamically based on crew functional state metrics.

### BRIEF DESCRIPTION OF THE FIGURES

FIG. 1 depicts RFA waypoint turn initiation points.

FIG. 2 depicts an RFA waypoint descent initiation.

### DETAILED DESCRIPTION OF THE INVENTION

The present invention is drawn to an automated flight control system which requires crew input during pre-programmed way points during the flight. Previous FMS designs were primarily bimodal—they provided manual modes and fully autonomous modes and virtually nothing in between. The modes available in the art were variations on full autonomy in different flight regimes, e.g. climb or cruise. The RFA FMS is inherently modeless, allowing for a continuum of support levels from safety of flight backup support (e.g. stall protection) to fully autonomous flight.

In the present invention, the crew is required to initiate all significant trajectory changes while the automation is responsible for following the flight plan trajectory between transitions and for supporting the crew in making transitions between flight plan segments. The flight crew is given multiple opportunities to initiate each transition in the flight plan trajectory and the FMS tracks the timeliness of the crew in initiating these changes. In the event that the flight crew fails to initiate a transition, the FMS assumes control, initiates the trajectory transition and attempts to reengage the crew in conduct of the flight. If this fails, the FMS alerts ATC.

The invention further includes an air traffic control environment, datalink from the ATC to the aircraft that provides instructions on amending the trajectory to ensure a safe landing. A datalink embodiment would be usable in the case of flight crew incapacitation or in the event the aircraft was controlled by hostile persons. It is envisioned that the control by the ATC would override instructions from the cockpit if there is confirmation or indication of crew incapacitation or a hostile takeover of the aircraft. If ATC assumes control of the aircraft due to crew incapacitation or hostile takeover, the RMA FMS would transmit data regarding its position and actions to ATC and respond to ATC trajectory changes sent via datalink. The RFA FMS would follow the trajectory as amended by ATC autonomously.

The real time function allocation aircraft flight management system of the invention modulates the level of support provided to a flight crew by aircraft automation to assist in conduct of a flight. The RFA assumes the existence of a 3- or 4-dimensional route to be followed during the flight and requires the crew to initiate every significant trajectory change along that route. By measuring the timeliness of crew inputs RFA detects degradation in crew performance and modulates the level of automation support provided. The objective of this design is to keep the crew engaged in the conduct of a flight and avoid loss of situational awareness that could compromise the crew's ability to respond in an emergency or unanticipated situation. The rationale for real-time function allocation between pilot and automation is reviewed extensively by NASA in developing its Naturalistic Flight Deck paradigm. (Schutte, P C, Goodrich, K H, Cox, D E, Jackson, E B, Palmer, M T, Pope, A T, Schlecht, R W, Tedjojuwono, K K and Trujillo A C, The Naturalistic Flight Deck System: An Integrated System Concept for Improved Single-Pilot Operations, NASA/TM-2007-215090) In NASA models in the past, there had been no mechanism for reallocating functionality other than the intent of the pilot or the aircraft straying too close to the limits of its performance (e.g. approaching stall). The current invention specifies both a means of detecting crew functional state and a method of responding to altered functional state with specific automation role assignments.

A sophisticated aircraft FMS provides navigation data to the crew, allows definition by the crew of a flight plan path, and interfaces with flight control and thrust control systems to provide fully automated control of all phases of flight except for takeoff and landing. The FMS exercises full autonomy to follow the flight plan path defined by the crew, while the crew is responsible for programming the FMS. Manual control is possible, with the FMS providing direction to the crew through a Flight Director system that provides advisory information as to the vertical and horizontal flight path through attitude and navigation display systems.

An RFA FMS typically operates in a region between fully autonomous and manual modes. The crew is required to initiate all significant trajectory changes and the automation provides precision path following based on the flight plan trajectory. It also supports flight crew by alerting them to required inputs and monitoring the timeliness of required crew inputs. In addition it tracks the timeliness of required flight crew inputs and uses the results to modulate the level of assistance provided.

The RFA paradigm requires a flight plan trajectory that conforms to the initial ATC clearance, which may be amended since initial clearance by the ATC. Initially the flight crew inputs this trajectory during flight planning. Any subsequent amendments by ATC may either be communicated by voice and input manually by the crew or communicated by datalink and accepted by the crew for incorporation into the flight plan trajectory. At each transition where a pilot input is required, RFA defines up to four points at which the crew may initiate the transition to the next segment. These points occur sequentially as the aircraft approaches the transition location. Failure to provide a control input within a defined time window represents a degraded level of crew functional state to manage the transition and the remainder of the flight. As each point and its associated input window is passed, the level of degradation increases.

For its full functionality, the RFA FMS is able to control all aspects of flight, including not only attitude and power control but also all ancillary systems such as flaps, landing gear, reverse thrust and brakes necessary for flight from takeoff to touchdown.

### Real-Time Function Allocation

The four positions defined at each transition point for a complete flight plan trajectory are:

1. Alert Transition Point

Arrival at this transition point, defined by a specific look-ahead time (typically 10 seconds) prior to initiating a transition, will cause the automation to display a transition path from the current to the next segment on the primary flight display (“PFD”) and also on the multifunction display (“MFD”; the MFD is typically a top-down map display). A pilot SELECT input on the controls received within a nominal time window (typically 2-4 seconds) after the alert will direct the automation to fly the proposed path without further input from the pilot. If the SELECT input is received after the Alert window but before the optimal point the automation will fly the transition path once it reaches the optimal point but the crew state will be degraded slightly. The SELECT input is a control input by the crew to select a specific function. The SELECT and other control inputs are made by using any number of control input devices as known in the art.

2. Optimal Transition Point

The Optimal transition point is the location at which an optimal intercept path from the current to the next segment begins. The optimal window begins at the Optimal transition point and lasts for the nominal window duration. An Optimal path requires a standard degree of control deflection and force to initiate the proposed maneuver to complete the maneuver without going outside the protected airspace defined for the inflection point. If the crew exerts a force on the maneuver control in the direction of the maneuver that exceeds a specific threshold (e.g., applying a right bank force in excess of 5 Newtons to the manual controls in order to signal a right turn), the automation accepts the input, maneuvers the aircraft to follow the transition path and couples to the next segment for further guidance.

3. Maximal Maneuver

The Maximal maneuver is the location at which a maneuver must begin in order to complete the transition to the next segment without exceeding a specified maximum degree of maneuver (e.g., g-force, angle of bank or deck angle). The pilot initiates the maneuver by making a control input that exceeds the initiation threshold. The RFA will accept the command and complete the maneuver using the maximal degree of maneuver.

4. Override

The Override transition point occurs either at the inflection point where the two segments join or at an earlier point if required to complete the transition without resulting in an excursion beyond the protected airspace boundaries. If the RFA initiates an override, it would switch to autonomous mode, complete the transition and remain in autonomous mode until the flight crew made an affirmative control input to reassert control. When the automation assumes control after an Override transition, an emergency alert would sound along with haptic signals (e.g. rumble strip-like vibrations of the stick). The crew would have to provide an “affirmative control input” to resume control. The affirmative control input can optionally include a requirement for the input of a security code or biometric identification to resume control.

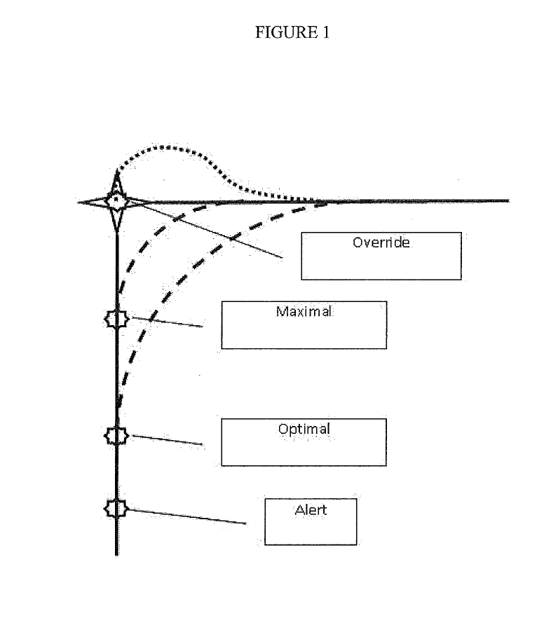

FIG. 1 illustrates example of such a strategy for a turn at a waypoint from one segment of a GPS route to another. FIG. 1 is a top-down view of a flight plan trajectory of an aircraft approaching a transition point for a turn. Each turn path has a window within which the pilot must initiate the transition maneuver (our preliminary estimate for window width is 2-4 seconds). RFA provides an aural alert when the aircraft reaches the Alert point. If the pilot accepts the intercept path by making a SELECT input within the alert window, RFA begins the turn at the optimal point and couples to the next segment. If the pilot fails to accept the maneuver within the prescribed window, the pilot may still use a SELECT input to authorize the turn but the crew state will be downgraded and the level of support enhanced for future transitions. If the crew has not selected the transition by the time the aircraft approaches the Optimal transition point, the RFA highlights the optimal path and provide an enhanced alert (visual and aural) approaching the optimal window. To initiate the maneuver the pilot must move the lateral control device in the turn direction in a way that exceeds an initiation threshold. The same sequence of events occurs at the Maximal transition point, if defined. After passing the Optimal transition point (or Override transition point if previously defined) the pilot may still manually make the transition to the next segment. This will cause the FMS to revert to manual mode. The pilot must reengage normal mode by selecting the subsequent segment for FMS guidance.

If the pilot does not initiate the turn by the time the aircraft reaches the Override transition point, RFA will assume control and perform the override maneuver to couple to the next segment. It will also initiate a MASTER CAUTION alert and require an affirmative pilot RESUME CONTROL input to return to the semi-autonomous mode.

Depending on the specifics of a particular inflection point in a flight plan path and the current aircraft speed and configuration, some of the defined behaviors may exceed legal, structural or procedural limits of the aircraft. At high speed, for instance, the angle of bank to achieve a standard rate turn may exceed the maximum allowable angle of bank. In such a case, the maximal maneuver and the optimal maneuver may be the same. In this case only two initiation opportunities and one pilot-initiated turn path may be presented.

In an alternate embodiment, the maximal point may be omitted. In this case, if the crew initiates a transition after the optimal window and before the Override transition point, the automation relaxes control in the maneuver channel(s) and allows the pilot to complete the maneuver manually. Upon completion of the maneuver the pilot will be required to reselect the subsequent segment for guidance before the automation resumes fully autonomous flight path control. The above embodiment encompasses a “fly-by” waypoint at which turn anticipation is allowed.

An alternative embodiment of the invention includes a procedure which is employed for a turn at a “fly-over” waypoint. Comparable RFA strategies are also used for other required behaviors executed in following an ATC cleared flight plan, such as flyover waypoint turns or climbs/descents. The RFA FMS is also be capable of managing configuration or speed changes as required, such as the transition to approach configuration during approach phase or slowing to adhere to speed limits at lower altitudes. Each such transition is handled in a manner similar to the above discussion of a waypoint turn, with the flight crew required to initiate each transition and a sequence of transition points defined as indicated above.

If the pilot initiates the maneuver after the alert point, in addition to providing an enhanced alert at the Optimal transition point the RFA will increase its level of support for the next maneuver. An increased level of support is to enhance the alert notification for the next maneuver, by using a simple aural tone as a standard alert and to enhance it by providing, in addition to the tone, a message on the PFD and a verbal alert if pilot attention is assumed to be compromised is envisioned in the invention. The RFA FMS also recognizes the SELECT input within the optimal window as a signal to complete the transition in addition to the possibility of initiating the maneuver with an input on the control device.

Additional embodiments include elements that enhance the level of automation support slightly in response to modest levels of crew performance degradation. Included is RFA automation that initiates the maneuver at the end of the optimal window rather than the override transition point.

The critical component of all embodiments is the requirement for the flight crew to initiate all transitions, the sequence of points and inputs to initiate the transitions, and the override ability to enter autonomous mode if the crew fails to make a required inputs in a timely manner.

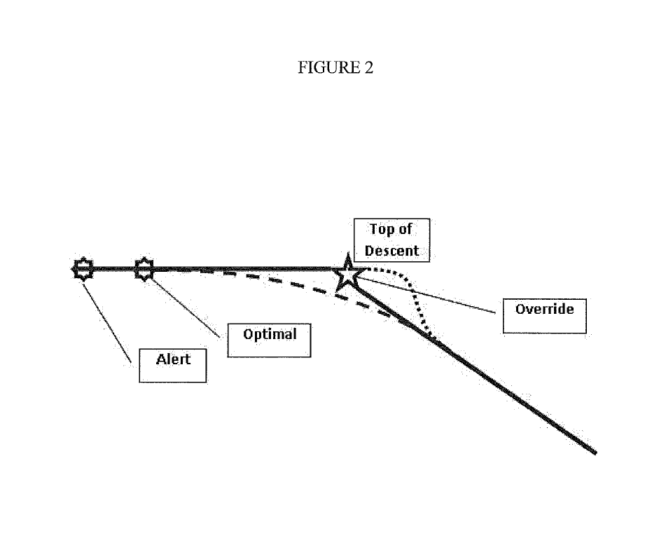

In addition to maneuvers at predefined airspace fixes or waypoints, the flight plan trajectory may require maneuvers to begin at a point in the cleared flight path other than a junction between two segments or a defined airspace element. Not to be limiting, a descent for arrival at a destination airport, could begin at a point determined by the maximum efficiency descent from the cruise altitude to the destination airport or initial approach fix. FIG. 2 depicts an RFA waypoint descent initiation from a lateral view of the flight plan trajectory of a flight flying at a constant altitude then reaching a waypoint to begin descent. Given a top of descent point, the RFA FMS would define Alert, Optimal, Maximal and Override transition points in a manner similar to that illustrated for the waypoint turn maneuver described above. The various transition points would be defined using more or less the same timing, regardless of the initiation point of the flight plan trajectory. For instance, the Alert transition point would occurs at the same 10 seconds interval prior to the Optimal transition point in the descent flight plan trajectory as in a longer flight plan trajectory. The Optimal transition point is the point at which the maneuver should be initiated to that it can intercept the next trajectory segment using a standard rate turn, standard rate of pitch increase or decrease, etc. as described above for a complete flight plan trajectory. The Maximal transition point is the point at which the maneuver should be initiated to that it can intercept the next trajectory segment using the maximum allowable rate of turn, of pitch increase or decrease, etc. The Override transition point is the point at which the two trajectory segments intersect.

In all embodiments of the invention, once the clearance has been accepted, the pilot may initiate the descent by making a SELECT input immediately or within the alert window. If the pilot does not initiate the maneuver by the end of the alert window, initiating a pitch-down (i.e., by a downward pitch input that exceeds a threshold force level) within the optimal initiation window will initiate the maneuver. If the pilot has not initiated the climb by the time the aircraft reaches the override point, the FMS will initiate a maximum performance descent and level off at the target altitude. On longer flights, if the flight plan trajectory includes a long period without a transition point, the RFA system may create an unscheduled requirement for a pilot input. This additional pilot input would require the RFA system to alert the pilot with an Unscheduled Alert Tone and visual indication. In this case the Alert, Optimal and Override transition points would all be along the path currently being used for guidance without the need for a transition.

For ATC clearances that are given with the intent that they take effect immediately (e.g., “Climb and maintain Flight Level 290” or “Turn right heading 170°, vectors to the ILS Runway 33L”), the RFA will create maneuver initiation points in real time, using for example:
1. an Alert transition point 5 seconds ahead of the aircraft current position;
2. an Optimal transition point 10 seconds ahead of the aircraft current position;
3. an Override transition point 20 seconds ahead of the aircraft current position.

In the absence of an ATC datalink to deliver clearance amendments, the flight crew will have to respond to ATC voice commands by programming the new trajectory. Once the trajectory has been amended, the RFA FMS would create timed points as suggested above. In an ATC datalink environment, cooperation of the crew would not be required.

In the event that the pilot deliberately departs from the flight plan trajectory, for example by resisting the attempt by the FMS to initiate an override turn, the FMS will transition to a lower level of automation and again monitor the crew's inputs using a method similar to crew lost communication procedures in a voice command ATC environment. If the crew does not edit the flight plan trajectory within a preset interval, the FMS will compute a path to the next flight plan waypoint and establish an inflection waypoint to return to this path. Once this is done, the method described above will be used to alert the crew to the upcoming turn point and the behavior described above will be followed. If the crew edits the trajectory after assuming primary control, the FMS will use the next waypoint in the edited fight plan and follow the procedure outlined above for departure from the flight plan trajectory.

A hostile takeover or total crew incapacitation would be recognized by the failure of the crew to respond to an upcoming transition by the Override transition point. In event of a hostile takeover, the crew would not respond with an affirmative response when the Override emergency alert occurred. This could require the use of a security code to prevent an inadvertent input, e.g. by a nonqualified crew member. Requirement of an input of a security code would also prevent hostile takeovers. The invention could also include a separate pilot input, verified by a security code, that indicates that a hostile takeover is imminent or has occurred.

In the current ATC environment, clearance for a specific approach is usually left to the end of the flight in the arrival environment. This allows ATC to specify an approach procedure and landing runway consistent with current conditions. In an ATC datalink environment, the FMS can alert ATC to an incapacitated crew and ATC can amend the clearance and thus the FMS flight plan trajectory via data link. In the current voice environment, the RFA FMS would have to establish procedures to insert an approach procedure into the flight plan trajectory without ATC input. This can easily be done using procedures derived from lost voice communication procedures. In the event that the crew is incapacitated, the RFA FMS can select the most probable approach procedure in use based on whatever information is available: current destination weather, forecast destination weather, typical prevailing winds, a default approach selected by the flight crew or an approach based on the available runways (e.g., longest runway). Having thus edited the flight plan trajectory, the FMS can follow the trajectory as outlined above.

In the event of crew incapacitation, as indicated above, numerous strategies are available to increase the level of support and alerting provided to the crew. Any such strategy need only serve to increase the probability both that the crew will reengage in conduct of the flight and that the flight will conform to airspace restrictions. If the crew becomes incapacitated and misses multiple required inputs, the RFA FMS would essentially revert to full automation and behave much like current FMS systems. Specifically, the RFA FMS would not wait until the override point at every trajectory change but would fly the optimal path at each inflection point until either touchdown or the crew reasserted control.

Also included is a simulator in which training of flight crew can be accomplished. Also included is software and hardware components of a simulator, and instructions. The simulator hardware includes, but is not limited to, a structure, monitor, control panel and data recording means. Feedback and voice command capability is also included. Also included is a heads-up display including, but not limited to visual notations during implementation of RFA alarms, transition points, waypoints and flight plan trajectory entries.

Also included are methods of using the system described herein. The invention includes a method to modulate the level of support provided to a flight crew by the RFA system aircraft automation to assist in conduct of a flight, including the steps of: providing an alert when the aircraft reaches the Alert point of a flight plan trajectory; beginning the programmed turn at the Optimal transition point and couples to the next segment, if the pilot accepts the intercept path by making a SELECT input within the alert window; highlighting the optimal path and providing an enhanced alert (visual and aural) when the Optimal window is approached, if the crew has not selected the transition by the time the aircraft approaches the Optimal transition point; and initiating the maneuver by the pilot by moving the lateral control device in the turn direction in a way that exceeds an initiation threshold. The method includes the same sequence of events occurring at the Maximal transition point, if defined in the flight plan trajectory. The method additionally includes a step that after passing the Optimal transition point (or Override transition point if previously defined) the pilot may still manually make the transition to the next segment, causing the FMS to revert to manual mode. An additional step requires that the pilot must reengage normal mode by selecting the subsequent segment for FMS guidance. If the pilot does not initiate the turn by the time the aircraft reaches the Override transition point, RFA will assume control and perform the override maneuver to couple to the next segment. The method includes initiating a MASTER CAUTION alert and requiring an affirmative pilot RESUME CONTROL input to return to the semi-autonomous mode.

The method above includes a step that if the pilot fails to accept the maneuver within the prescribed window, the pilot still uses a SELECT input to authorize the turn but the crew state will be downgraded and the level of support enhanced for future transitions.

The method additionally includes amending the flight plan trajectory by the ATC either by communicated by voice and input manually by the crew or communicated by datalink and accepted by the crew for incorporation into the flight plan trajectory.

In an alternate embodiment, the method includes the omission of the Maximal transition point. In this embodiment, if the crew initiates a transition after the optimal window and before the Override transition point, the automation relaxes control in the maneuver channel(s) and allows the pilot to complete the maneuver manually. Upon completion of the maneuver the pilot will be required to reselect the subsequent segment for guidance before the automation resumes fully autonomous flight path control. The method of the above embodiment encompasses a “fly-by” waypoint at which turn anticipation is allowed.

An alternative method embodiment of the invention includes a procedure which is employed for a turn at a “fly-over” waypoint. Comparable RFA strategies are also used for other required behaviors executed in following an ATC cleared flight plan, such as flyover waypoint turns or climbs/descents. The RFA FMS is also be capable of managing configuration or speed changes as required, such as the transition to approach configuration during approach phase or slowing to adhere to speed limits at lower altitudes. Each such transition is handled in a manner similar to the above discussion of a waypoint turn, with the flight crew required to initiate each transition and a sequence of transition points defined as indicated above.

If the pilot initiates the maneuver after the alert point, in addition to providing an enhanced alert at the Optimal transition point the RFA will increase its level of support for the next maneuver. An increased level of support is to enhance the alert notification for the next maneuver, by using a simple aural tone as a standard alert and to enhance it by providing, in addition to the tone, a message on the PFD and a verbal alert if pilot attention is assumed to be compromised is envisioned in the invention. The RFA FMS also recognizes the SELECT input within the optimal window as a signal to complete the transition in addition to the possibility of initiating the maneuver with an input on the control device.

Additional method embodiments include elements that enhance the level of automation support slightly in response to modest levels of crew performance degradation. Included is RFA automation that initiates the maneuver at the end of the optimal window rather than the override transition point.

A method of the invention includes recognizing a hostile takeover or total crew incapacitation by detecting the failure of the crew to respond to an upcoming transition by the Override transition point. In event of a hostile takeover, the crew would not respond with an affirmative response when the Override emergency alert occurred. An affirmative response could require the use of a security code to prevent an inadvertent input, e.g. by a nonqualified crew member. The invention also includes a inputting by the pilot, a second security code, that indicates that a hostile takeover is imminent or has occurred.

The invention also includes a method of amending the clearance and thus the flight plan trajectory via an ATC datalink, whereby the FMS alerts the ATC to an incapacitated crew and ATC can thus amend the clearance. In the event that the crew is incapacitated, the RFA FMS selects the most probable approach procedure in use based on whatever information is available: current destination weather, forecast destination weather, typical prevailing winds, a default approach selected by the flight crew or an approach based on the available runways (e.g., longest runway). Having thus edited the flight plan trajectory, the FMS follows the trajectory as outlined above.

### Use of the Invention

The RFA is used as an element of a Flight Management System that is capable of following a flight plan path with full autonomy but in normal conditions requires the flight crew to initiate all significant trajectory changes. The pilot must use typical FMS control systems to create an initial flight plan and to modify it as necessary in response to Air Traffic Control or pilot initiated changes in the flight plan. Once the initial flight plan is established, the RFA FMS will display the flight plan path on PFD and MFD screens and provide alerts and other support to the pilot to follow the path. The pilot will use the physical flight control inceptors (typically a joystick, rudder pedals, one or more power selectors and ancillary controls such as buttons, knobs, switches, keyboards, computer mice and other typical input devices) to initiate all trajectory changes. An RFA FMS will support both manual and fully autonomous modes, providing flight control directions through typical Flight Director displays in manual mode. However, as indicated above, the automation tracks the timeliness of required flight crew inputs and modulate the level of support provided to the flight crew, including a fully autonomous level of support engaged either manually or in response to flight crew failure to provide required inputs in a timely manner. The RFA FMS is capable of fully autonomous flight plan path following from takeoff to touchdown.

The RFA FMS will also include all the typical features of a current FMS for entering and editing the flight plan trajectory.

The RFA FMS: requires that the pilot creates and edits a flight plan trajectory to the destination airport; initiates all significant trajectory changes; and tracks the timeliness of required inputs to determine when the crew's functional capability is degraded. If the crew's performance is degraded, the RFA modulates its level of support to ensure that the flight plan path is followed within the limits defined by the ATC authority with minimal effort by the flight crew. In the event that the flight crew is incapacitated (i.e., fails to make multiple required inputs) the system of the invention assumes autonomous control and follows the rest of the flight plan trajectory, issues an alarm to the crew to reassert control of the aircraft and/or notifies ATC in the event that the crew is incapacitated and fails to respond to the alarm. In all embodiments, when the automation assumes control after an Override transition, an emergency alert would sound along with haptic signals (e.g. rumble strip-like vibrations of the stick). The crew would have to provide an “affirmative control input” to resume control.

The advantage of the RFA approach of the invention is that in all embodiments, with minimal requirements for specific control inputs, it forces the flight crew to remain engaged in the conduct of the flight and enhances situational awareness. It also can recognize crew incapacitation or functional degradation and notify ATC if necessary in such an event. When crew incapacitation is recognized, the RFA FMS has the ability to select an approach path and land the aircraft autonomously. This contrasts with most typical FMS systems, which can and have flown past destinations because the flight crew fell asleep and neglected to modify the flight plan to transition from cruise to landing.

Working Examples

### EXAMPLE 1

### Effects of External Distraction and Pilot Response

An RFA FMS prototype was developed and tested the effects of external distraction on the timeliness of required flight crew inputs in an RFA FMS simulation. Test subjects were instrument instructors (CFII rated pilots). Each test was a flight from just outside the terminal area of the Louisville, Ky. airport to touchdown. The test scenario involved several trajectory changes, each of which the pilot was required to initiate. An external distraction device was used to degrade the test subject's timeliness in making required inputs. The distraction device randomly illuminated one of two LEDs positioned just outside the test subject's line of vision while sounding an alert tone. The subject had to look away from the simulation to determine which LED was illuminated and press an associated button to extinguish it. Distraction periods were 15, 10 and 5 seconds. The results showed that the delay between presentation of the stimulus requiring the input and the actual input was longest for the highest distraction frequency (shortest distraction period), showing that timeliness is a good measure of functional capability. This concept is at the heart of the RFA design. An RFA simulator to explore the RFA strategies is included in the invention.

Having now fully described this invention, it will be understood to those of ordinary skill in the art that the same can be performed within a wide and equivalent range of conditions, formulations, and other parameters without affecting the scope of the invention or any embodiment thereof. All patents and publications cited herein are incorporated by reference in their entirety.

We claim:

1. A real time allocation flight management system comprising:
an aircraft flight management system; and
a flight plan trajectory programmed into said aircraft flight management system; and
a control means for an aircraft, said means comprising said aircraft flight management system control of engine power, attitude, flaps, landing gear, thrust, reverse thrust and brakes; and
a flight plan trajectory means for calculating a planned path and inputting the planned path and waypoints into the aircraft flight management system; and
an alarm system which alerts a flight crew to initiate trajectory changes prior to each transition waypoint in the flight plan trajectory; and
a system for following the flight plan trajectory between trajectory transitions and for supporting the crew in making transitions between flight plan segments; and
at least an additional alarm in the event the flight crew does not initiate a trajectory transition, and in the event that the flight crew continues to fail to initiate a trajectory transition, the flight management system assumes control, initiates the trajectory transition and attempts to reengage the crew in conduct of the flight, and subsequently alerts an air traffic control station.

2. The real time allocation flight management system of claim 1, comprising a means wherein said real time allocation flight management system is capable of receiving a datalink from an air traffic control station.

3. The real time allocation flight management system of claim 2, comprising a means wherein the datalink from an air traffic control station is capable of overriding instructions from the flight crew in the event of a hostile takeover of the aircraft.

4. The real time allocation flight management system of claim 2, comprising a means wherein the datalink from an air traffic control station is capable of controlling the aircraft in the event that the crew is incapacitated.

5. The real time allocation flight management system of claim 1, comprising a means wherein a deliberate departure from the flight plan trajectory will cause the real time allocation flight management system to monitor any inputs from the flight crew and compute a path to a next flight plan waypoint and is capable of establishing an inflection waypoint to return to the flight plan trajectory.

6. A method wherein the real time allocation flight management system of claim 1, provides an emergency auditory, visual and/or haptic alert which is transmitted to the flight crew upon arrival to an Override transition point, and
upon a failure of the flight crew to respond to said emergency alert at said Override transition point, the aircraft flight management system assumes control of the aircraft, through the remainder of the flight plan trajectory,
and to resume control of the aircraft, upon an affirmative control input by the crew.

7. A method of modulating the level of support provided to a flight crew by real time allocation flight management system to assist in conduct of a flight, comprising the steps of:
providing an alert when the aircraft reaches the Alert point of a flight plan trajectory; and
beginning the programmed turn at an Optimal transition point; and
coupling the optimal transition point to the next segment; and
if the pilot accepts the intercept path by making a SELECT input within the alert window, then highlighting an optimal path by providing an enhanced alert (visual and aural) when an Optimal window is approached; or
if the flight crew has not selected a transition by the time the aircraft approaches the Optimal transition point, then initiating at least an additional alarm; and
in the event that the flight crew continues to fail to initiate a trajectory transition, the flight management system assumes control, initiates the trajectory transition and attempts to reengage the crew in conduct of the flight, and subsequently alerts an air traffic control station.
